(19) United States
(12) Patent Application Publication
(10) Pub. No.: US 2011/0032380 A1
(43) Pub. Date: Feb. 10, 2011

(54) PRINTING SYSTEM AND METHOD

(75) Inventor: Yuki Ishida, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/831,073

(22) Filed: Jul. 6, 2010

(30) Foreign Application Priority Data
Aug. 10, 2009 (JP) 2009-186144
Jun. 24, 2010 (JP) 2010-143923

(51) Int. Cl. H04N 9/73

(52) U.S. Cl. 348/223.1; 348/E09.051

(57) ABSTRACT

Color charts each formed from patches corresponding to different colors are uniformly arranged at different positions on a print medium almost equal in size to an object to be photographed by a camera. The printed color charts are photographed by the camera one by one so that one color chart falls within the photographing range of the camera while keeping the distance between the camera and the print medium constant, acquiring photographing data. Under the same conditions, parts of the object are photographed one by one so that a part of the object at the same position as the position of one photographed color chart on the print medium falls within the photographing range of the camera, acquiring photographing data. Color coordinate values are acquired from the photographed color charts. By using the values, the color of the acquired photographing data is converted. The printing apparatus prints the converted data.

### BACKGROUND OF THE INVENTION

1. Field of the Invention

The present invention relates to a printing system and method for printing an image.

2. Description of the Related Art

Japanese cultural heritages such as fusumas (Japanese sliding doors), Japanese folding screens, and pictures cannot avoid deterioration year after year under the influence of the temperature, humidity, sunlight, and the like. In order to hand down valuable cultural heritages to posterity, the restoration of deteriorated cultural heritages is being promoted. As another attempt, the careful storage of cultural heritages, and replacing them with high-precision replicas for an ordinary exhibition is becoming more popular. Replicas are also lent to a school, event, or the like so that people can feel close to the cultural heritages, raising the awareness of such items. In general, a replica is made by having it copied it by hand by a craftsman. However, making a replica by hand takes time, and the resulting replica depends on the skill of the craftsman. One method to make a high-precision replica that takes less days to make, involves using a digital camera and printing apparatus.

Japanese Patent Laid-Open No. 5-103336 discloses a method of obtaining an image output in the same color as that of an object. More specifically, an object and color chart are photographed by a digital camera. A color conversion table is created from R (Red), G (Green), and B (Blue) video signals acquired from video data of the color chart, and R (Red), G (Green), and B (Blue) input color signals of the color chart. By using color conversion table, the color of video data of the object is converted.

However, photographing the color chart by a digital camera in the color matching method suffers illumination nonuniformity in which the brightness of the illumination is perceived differently depending on the position on the color chart even during irradiation with uniform light. Especially when the illumination nonuniformity arises in a color chart read value, no correct color conversion table can be created. As a result, a color mismatch occurs in part of a replica picture. A method of correcting the illumination nonuniformity is shading correction. Japanese Patent Laid-Open No. 9-139882 discloses a method of correcting shading. More specifically, illuminance correction data is created by photographing white paper or the like by a digital camera before photographing an object. The illuminance correction data is applied when photographing an object.

However, shading correction can correct the brightness difference, but cannot correct the color difference. The reason why the color changes depending on the position on the color chart is the dependence of the spectral reflectance on the angles of the light source, color chart, and camera, as shown in FIG. 13. When light emitted by the light source is reflected by the chart and read by the camera, the incident angle and reflection angle change depending on the position on the chart, so the spectral reflectance of the chart also changes.

FIG. 14 is a schematic view showing the difference in spectral energy depending on the position on the chart. FIG. 14 shows that as the spectral energy of the light source changes, a spectral energy received by the camera changes, too.

When the light source and camera are fixed, light emitted by the light source is reflected by the chart. In reading by the camera, the color changes depending on the position on the chart. This is because a spectral energy received by the camera changes depending on the position on the chart. An object reflects light from the light source in two ways. One is diffuse reflection: light emitted by the light source enters an object once, undergoes light absorption unique to the object, and is reflected again uniformly in all directions. The diffuse reflection does not generate a color difference dependent on the position on the chart. The other is mirror reflection: light is reflected by the surface of an object so that most beams become symmetrical about the normal of the object. The mirror reflection changes the color (brightness) depending on the position on the chart. Light reflected by the object is given by the linear sum of these two types of beams:

S(x,y)=c(x,y)βS_{w}+d(x,y)S_{w}

where S(x,y) is the spectral energy of observed light at a position (x,y) in an image, Sw is the spectral energy of the light source, and β is the spectral reflectance. The first term indicates the diffuse reflection component, and the second term indicates the mirror reflection component. c(x,y) and d(x,y) are the mixing ratios of these components. This equation means that the color changes depending on the position.

Since the spectral reflectance of the color chart changes depending on the camera position on the color chart, the color is perceived differently. When the camera and light source are satisfactorily spaced apart from the chart, the incident angle and reflection angle with respect to the light source and camera hardly vary even upon a change of the position on the chart. The angular dependence of the spectral reflectance is considered to have little influence.

However, it is difficult and not practical to space the camera and chart fully apart from each other under a predetermined photographing condition such as photographing of an art object. It is also possible to reduce the influence of the angular dependence of the spectral reflectance by irradiating the chart using a plurality of light sources. However, to satisfactorily reduce this influence, the chart needs to be irradiated at all angles using a plurality of light sources, which is not practical. The influence may be reduced by arranging patches on the color chart at the center of variations of the spectral reflectance on the color chart. However, it is difficult to find out the exact location from the relationship between the light source, the chart, and the camera. Particularly when the color chart is irradiated using a plurality of light sources, it is very difficult and not practical to find out the center of variations of the spectral reflectance on the color chart.

### SUMMARY OF THE INVENTION

An aspect of the present invention is to eliminate the above-mentioned problems with the conventional technology.

The present invention provides a printing system and printing method for reducing a color difference generated under the influence of the angular dependence of the spectral reflectance.

The present invention in its first aspect provides a printing method executed in a printing system including a photographing unit for photographing an object, an information processing apparatus, and a printing apparatus, the method comprising:

a first acquisition step of causing the information processing apparatus to acquire photographing data obtained by photographing, by the photographing unit, a color chart formed from a plurality of patches including at least two patches representing a predetermined color;

a second acquisition step of causing the information processing apparatus to acquire photographing data obtained by photographing the object by the photographing unit under the same ambient light as an ambient light used to photograph the color chart in the first acquisition step;

a correction step of causing the information processing apparatus to correct, based on the photographing data of the color chart that has been acquired in the first acquisition step, the photographing data of the object that has been acquired in the second acquisition step; and

a printing step of causing the information processing apparatus to print by the printing apparatus using the photographing data of the object that has been corrected in the correction step.

The present invention in its second aspect provides a printing system including a photographing unit for photographing an object, an information processing apparatus, and a printing apparatus, the system comprising:

a first acquisition unit configured to acquire photographing data obtained by photographing, by the photographing unit, a color chart formed from a plurality of patches including at least two patches representing a predetermined color;

a second acquisition unit configured to acquire photographing data obtained by photographing the object by the photographing unit under the same ambient light as an ambient light used to photograph the color chart;

a correction unit configured to correct, based on the photographing data of the color chart that has been acquired by the first acquisition unit, the photographing data of the object that has been acquired by the second acquisition unit; and

a printing unit configured to print by the printing apparatus using the photographing data of the object that has been corrected by the correction unit.

The present invention can reduce a color difference generated under the influence of the angular dependence of the spectral reflectance that arises from the position of a light source for irradiating an object, and that of a photographing unit.

Further features of the present invention will become apparent from the following description of exemplary embodiments with reference to the attached drawings.

### BRIEF DESCRIPTION OF THE DRAWINGS

FIG. 1 is a view showing the overall arrangement of a printing system according to an embodiment of the present invention;

FIG. 2 is a view schematically showing the arrangement of an information processing apparatus 1;

FIG. 3 is a view schematically showing the arrangement of a printing apparatus 2;

FIG. 4 is a view schematically showing the arrangement of a camera 3;

FIG. 5 is a view for explaining the RGB value of a color chart;

FIG. 6 is a view for explaining an RGB value obtained by photographing the color chart;

FIG. 7 is a flowchart showing the sequence of a printing method;

FIG. 8 is a flowchart showing the sequence of processing by the information processing apparatus 1;

FIG. 9 is a flowchart showing the sequence of processing by the printing apparatus 2;

FIG. 10 is a flowchart showing the sequence of processing by the camera 3;

FIG. 11 is a view for explaining a color conversion table;

FIG. 12 is a view for explaining another example of the color chart;

FIG. 13 is a view for explaining the angular dependence of the spectral reflectance; and

FIG. 14 is a graph showing the difference in spectral energy depending on the position on the chart.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a repetitive description thereof will be omitted. Building blocks necessary for the embodiment will be described first, and then details of processing will be explained.

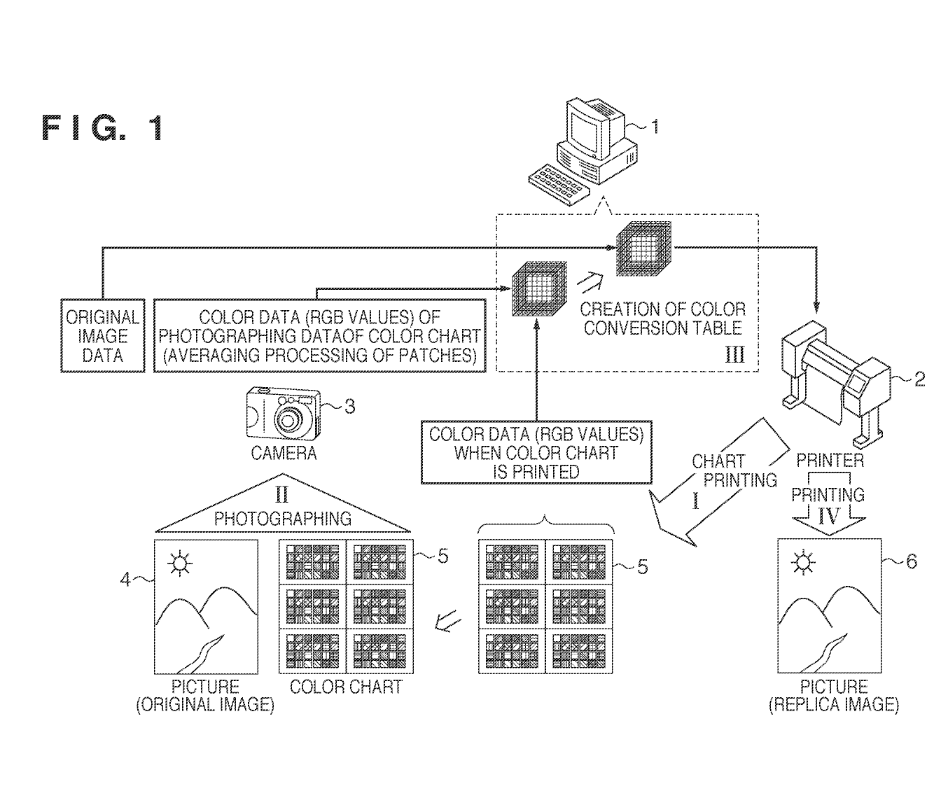

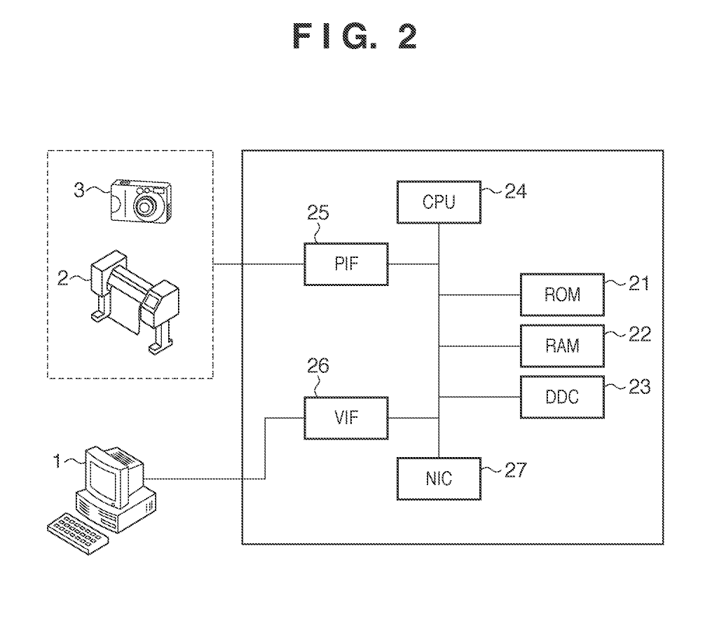

FIG. 1 is a view showing the overall arrangement of a printing system according to an embodiment of the present invention. The printing system includes an information processing apparatus 1, a printing apparatus 2, and a camera 3 serving as a photographing unit. FIGS. 2, 3, and 4 are views schematically showing the arrangements of the information processing apparatus 1, printing apparatus 2, and camera 3. As shown in FIG. 2, the information processing apparatus 1 includes a ROM 21, RAM 22, DDC (Disk Drive Controller) 23, CPU 24, PIF (Peripheral Interface) 25, VIF (Video Interface) 26, and NIC 27. These components are connected to each other via a bus, and can transmit/receive data. The VIF 26 is an interface with the display, and the CPU 24 can control the display via the VIF 26. The DDC 23 inputs/outputs data to/from various recording media such as a Floppy® disk, compact disk, USB memory, and HDD. The NIC 27 inputs/outputs data to/from various devices via a network. The PIF 25 inputs/outputs data to/from various devices connected to the information processing apparatus 1. The PIF 25 is connected to the printing apparatus 2 and camera 3. The form of connection between the PIF 25 and various devices is not limited to one form such as a dedicated cable, and may be another connection form such as wireless connection or USB connection. Data can also be input/output via the NIC 27 and DDC 23. Note that the information processing apparatus 1 has a general arrangement, but suffices to be a device having data input/output and data calculation/recoding functions. For example, if the printing apparatus 2 and camera 3 can implement these processing functions, they may be used as the information processing apparatus 1.

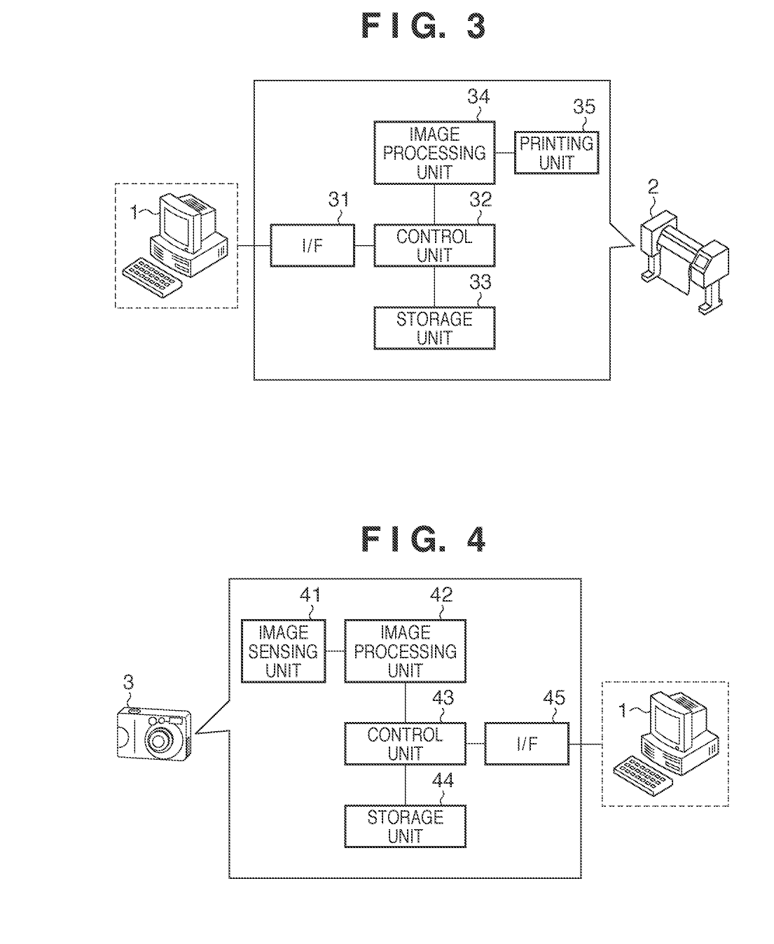

As shown in FIG. 3, the printing apparatus 2 includes an I/F 31, control unit 32, storage unit 33, image processing unit 34, and printing unit 35. The I/F 31 receives image data from an external device. The control unit 32 controls data processes associated with the printing apparatus 2, including job management, image processing, and print control. The storage unit 33 stores firmware and print parameters. The storage unit 33 also functions an intermediate buffer between processes and stores intermediate data. The image processing unit 34 performs image processes such as image data color conversion and N-ary processing. The printing unit 35 performs print processing in accordance with a predetermined print method for image data processed by the image processing unit 34. Note that the printing apparatus 2 is an inkjet printing apparatus, but another printing apparatus such as a laser or sublimation type is also available.

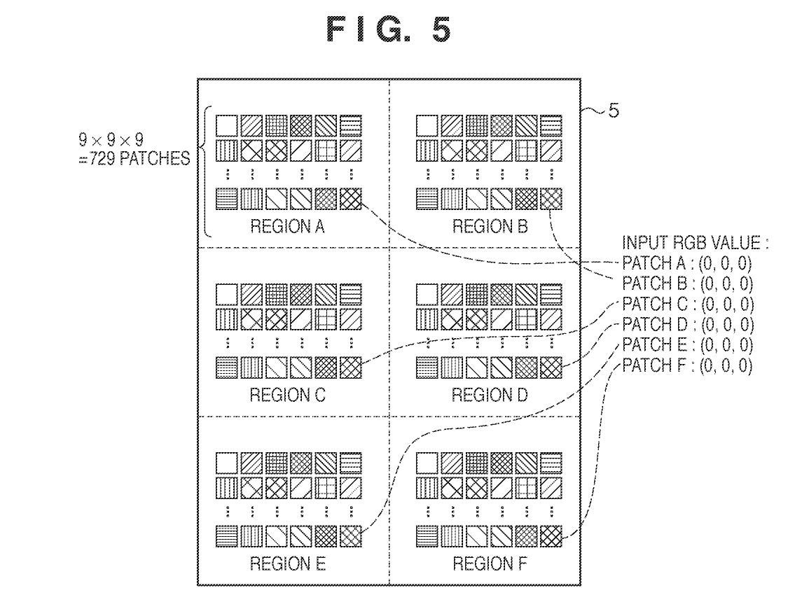

As shown in FIG. 4, the camera 3 includes an image sensing unit 41, image processing unit 42, control unit 43, storage unit 44, and I/F 45. A CCD mounted in the image sensing unit 41 can obtain a photographing signal. The signal obtained by photographing undergoes image processes such as color conversion processing and filter processing by the image processing unit 42, is converted into image data, and stored in the storage unit 44. The control unit 43 controls each processing. The control unit 43 transmits image data to the information processing apparatus 1 via the I/F 45. Note that the camera 3 means a wide variety of devices which convert an image into a digital image. For example, even an image recorded on an analog recording medium such as a film is also usable in the printing system as long as it can be converted into a digital image later.

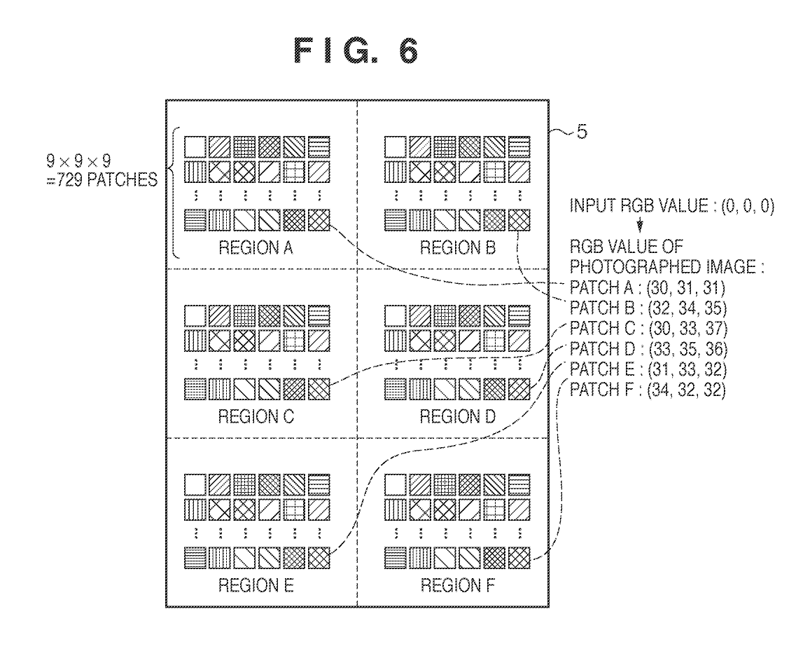

A color chart will be explained with reference to FIG. 5. As shown in FIG. 5, a plurality of color charts used in the printing system are arranged one by one in regions obtained by equally dividing a print medium into rectangular regions on N rows×M columns (3 rows×2 columns in the embodiment). In the respective regions, patches in the same color are arranged. In the following description, a color chart 5 means the print medium bearing a plurality of color charts. A patch whose color data (input RGB value) is expressed by (R: 0, G: 0, B: 0) is arranged in each region obtained by dividing the color chart into six. The color data is given by coordinate values defined in the color space.

Patches arranged in each of the six divided regions are tone patches of primary colors and N-th order colors necessary to create a color conversion parameter (also called a color conversion LUT or color conversion table) serving as correction data in the present invention. For example, each of the R, G, and B colors is divided into nine tones, and a combination of 9×9×9=729 patches is arranged in each of regions A to F shown in FIG. 5. By increasing the number of divided tones, a finer color conversion parameter can be created. The color conversion parameter creation method and the patch arrangement necessary to create it are a generally known method and arrangement.

FIG. 12 is a view showing a modification of the color chart 5. For example, as shown in FIG. 12, information other than patches, such as date and time information 1201, position detection mark 1203, chart identification mark, image, and pattern, may be printed on the color chart 5. Patches not used for the color conversion parameter may be printed and used to detect patch positions. As a consequence, the total number of patches may differ between the regions. Color lines 1202 may be printed on the two ends of the color chart 5 to avoid nonuniformity of the printing apparatus at the ends of the color chart 5. The color chart 5 may be divided into regions using a curve.

As a region division method which reduces the influence of the angular dependence of the spectral reflectance on the color chart 5, parting lines are drawn in at least three or four directions using the center of the color chart 5 as a reference so that color patches in the same color are arranged to be satisfactory spaced apart from each other on the sheet surface. After that, the color chart 5 is desirably divided into three or four regions. In the embodiment, RGB is used as patch color data. Instead, well-known color data capable of expressing a CMYK, CIE L*a*b*, XYZ, HSB, or HLS uniform color space using coordinate axes is also available.

As shown in FIG. 5, a plurality of patches in the same color are distributed on the color chart 5 to cover the sheet surface. When the color chart 5 is illuminated and photographed by a camera, the RGB values of patches influenced by the angular dependence of the spectral reflectance on the color chart 5 can be acquired. In the color chart 5 of FIG. 12, patches in the same color are arranged at different positions on the sheet surface so that they are aligned in neither the vertical nor horizontal direction, that is, in neither the same column nor row on the sheet surface, in order to enhance the dispersion of the patch arrangement. For example, when illumination light irradiates the chart along a line connecting the camera and chart, and patches in the same color are aligned in the horizontal direction, spectral reflectances acquired by the camera become equal. This patch arrangement hardly eliminates the influence of the angular dependence. In general, printing nonuniformity of a printer tends to appear in the vertical and horizontal directions in the paper conveyance direction. The color chart 5 is effective even for eliminating the influence of printing nonuniformity. An example of the use of the color chart 5 will be described later in the embodiment.

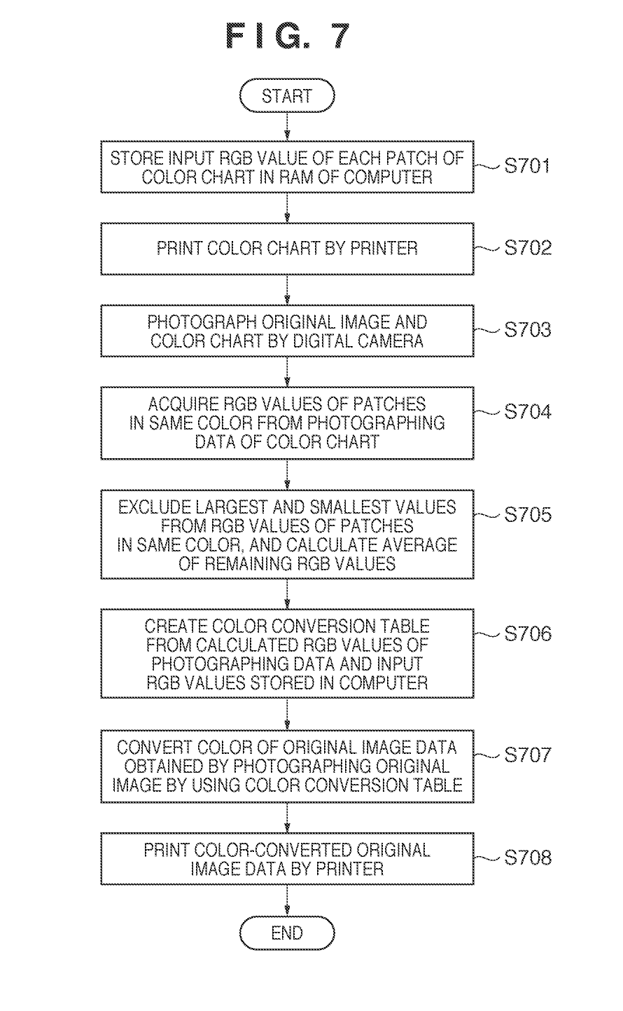

The color chart 5 and printing method in the embodiment will be described. For example, a case in which an object such as a Japanese folding screen, Japanese sliding door, or black-and-white drawing is photographed by the camera to make a replica will be explained. FIG. 7 is a flowchart showing the sequence of the printing method in the embodiment.

The RAM 22 of the information processing apparatus 1 stores the input RGB value of each patch of the color chart 5 (S701). The color chart 5 may be stored in advance in the information processing apparatus 1 or printing apparatus 2. When printing the color chart 5, the arrangement of the color chart 5 may be determined and dynamically generated. In the embodiment, the color chart 5 is stored in the information processing apparatus 1. The color chart 5 is divided into six regions. In the respective regions, six patches having the same input RGB value are arranged. The RAM 22 stores patches on the color chart 5 and their input RGB values in correspondence with each other. The information processing apparatus 1 transmits image data of the color chart 5 to the printing apparatus 2 via the PIF 25. The printing apparatus 2 receives the image data of the color chart 5 and prints it (S702: color chart printing). A printing apparatus having a color calibration function executes calibration under stable conditions and keeps the output state of the printing apparatus constant. The color chart 5 desirably uses paper (for example, Japanese paper) of the same type as that of paper used to print a replica image 6. Further, print conditions regarding printing such as an ink color conversion parameter and binarization parameter are desirably the same as those used to print the replica image 6. The color chart 5 is satisfactorily dried before photographing it so as to stabilize the color. Although the drying time changes depending on print conditions, the color chart 5 needs to be dried for at least 2 h when a pigment is used in an inkjet printing apparatus.

Then, the user photographs an original image 4, the replica image 6 of which is to be printed, and the color chart 5 with the camera 3 (S703). When thin paper such as Japanese paper is used as print paper, a lining used to exhibit the replica image is prepared and set for photographing the color chart 5. When photographing an object represented by high-resolution original image data, a pan head for fixing the camera 3 is used. While moving the camera 3 up, down, right, and left with respect to the original image serving as an object, the user divisionally photographs the original image. The photographed image data are then composited.

An example of photographing in the embodiment will be explained. In the following description, an object and the printed color chart 5 have the same size, and a region to be photographed in each of the object and color chart 5 is divided into, for example, six. In one region, the spectral reflectance is regarded not to depend on the angle, and light emitted by the light source is regarded to be uniform. One light source is fixedly set. The camera is set at one point on the pan head and can face an arbitrary three-dimensional orientation. First, the user sets the color chart 5 at a distance close to the camera so that the spectral reflectance depends on the angle. The user photographs the color chart 5 so that only one region (for example, region A) out of the six divided regions falls within the photographing range of the camera, thereby acquiring photographing data (first acquisition). Then, the user removes the color chart 5 and sets the object such as a Japanese folding screen at the same position. With the camera, the user photographs one region (for example, part of the object at the same position as region A) out of the six divided regions of the object, thereby acquiring photographing data (second acquisition). The user repeats this work for the six regions (region A to region F). It is desirable to photograph the color chart and object under the same ambient light. This is because, if the camera and light source are not set at the same position in photographing the color chart and the object, the color difference cannot be accurately corrected. The color chart and object need not be photographed simultaneously. However, it is necessary to emit light from the same light source at the same position, and set the camera at the same position. In the embodiment, the color chart and object are divisionally photographed. However, the present invention is not limited to this, and a plurality of regions may be photographed at once without dividing the color chart and object.

The printing system also performs shading correction to correct shading caused by illumination nonuniformity, sensitivity nonuniformity of the optical system of the camera 3, and the like. Shading correction will be exemplified. The user sets a white board at the photographing point of the original image 4 and color chart 5, and photographs it with the camera 3. Based on an image signal from the camera 3, data indicating the illumination distribution at the photographing point is obtained. Illuminance correction data indicating a necessary illuminance correction amount is obtained from the data indicating the illumination distribution, and recorded in the information processing apparatus 1. The illuminance correction data is applied to a photographed image acquired from the camera 3, achieving shading correction. Also, the illuminance correction data is applied to photographing data of the color chart 5, performing shading correction. Shading correction can correct the brightness, but it is difficult to correct the color difference. However, the influence of the color difference can be reduced using the color chart 5 to be described later.

Next, the information processing apparatus 1 acquires the RGB values of patches in the same color from photographing data of regions A to F of the color chart 5 (S704). In general, the RGB values of patches in the respective regions of the color chart 5 are different because of the angular dependence of the spectral reflectance. Hence, the information processing apparatus 1 acquires and averages pixel data (RGB values) of patches in the same color. The information processing apparatus 1 executes the same processing for patches corresponding to all colors, obtaining color data (photographing RGB value) from one photographed image for a plurality of patches in the same color. The color chart 5 has a total of six patches in the same color (input RGB value) in the six regions.

For example, as shown in FIG. 6, photographing RGB values corresponding to the input RGB value (0, 0, 0) indicating black are (30, 31, 31) in region A, (32, 34, 35) in region B, (30, 33, 37) in region C, (33, 35, 36) in region D, (31, 33, 32) in region E, and (34, 32, 32) in region F. Based on the photographing RGB values of the respective regions on the color chart 5, the information processing apparatus 1 calculates one photographing RGB value optimum for creating a color conversion parameter (S705). As a calculation method for excluding the influence of a singular value from a plurality of data, for example, a plurality of data are averaged to reduce the influence of the singular value. It is also possible to set a threshold for color variations of a plurality of data, exclude data larger or smaller than the threshold, and average the remaining data. In the embodiment, the largest and smallest data in variations of data are excluded to average the remaining data. However, another calculation method is also applicable to the embodiment.

For example, the R value in the photographing RGB value indicating black is 30 in region A, 32 in region B, 30 in region C, 33 in region D, 31 in region E, and 34 in region F. The values in regions A and F which are the lower and upper limits among these values are excluded, and the remaining values are averaged, obtaining an R value “32”. This calculation is also done for the G and B values. As a result, the photographing RGB value for the input RGB value (0, 0, 0) is (32, 33, 34). The acquired photographing RGB value is close to the center of color variations on the sheet surface. The same processing is executed for the remaining patches. In this case, pixel data in patches are temporarily averaged to calculate the RGB value of each patch. Alternatively, all pixel data which form patches may be acquired from patches in the same color on the color chart to calculate an optimum photographing RGB value from all the pixel data. The arrangement of the embodiment is also applicable to this case.

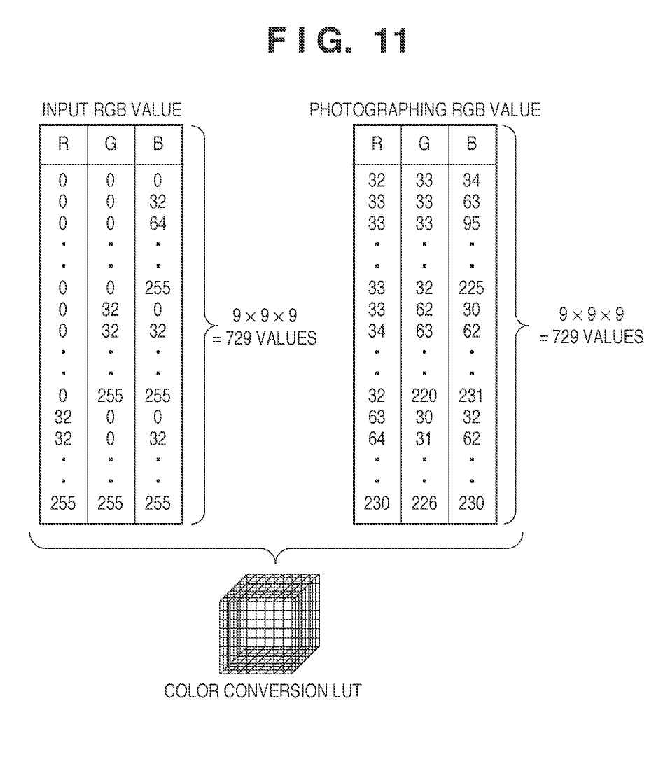

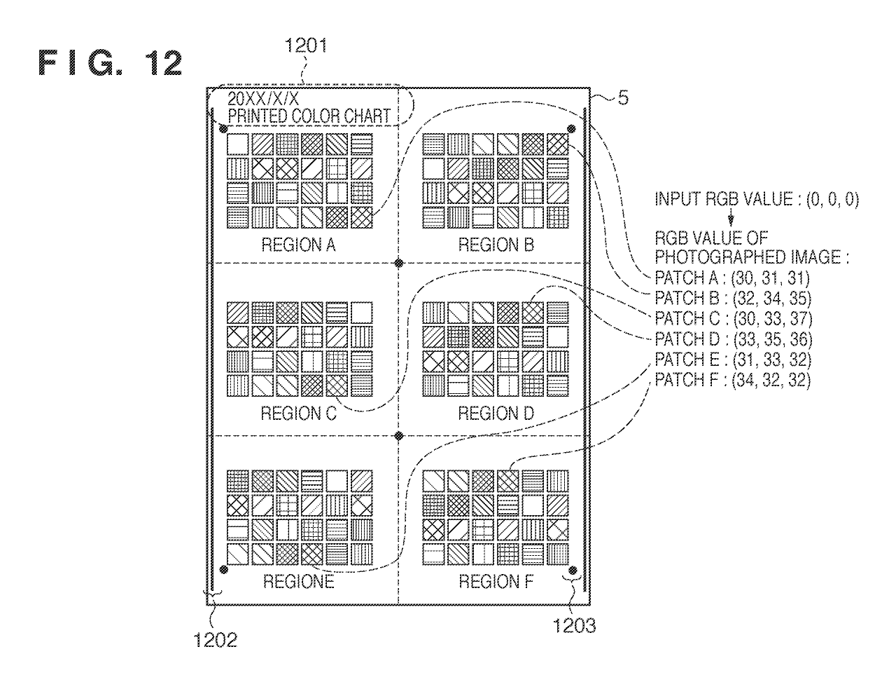

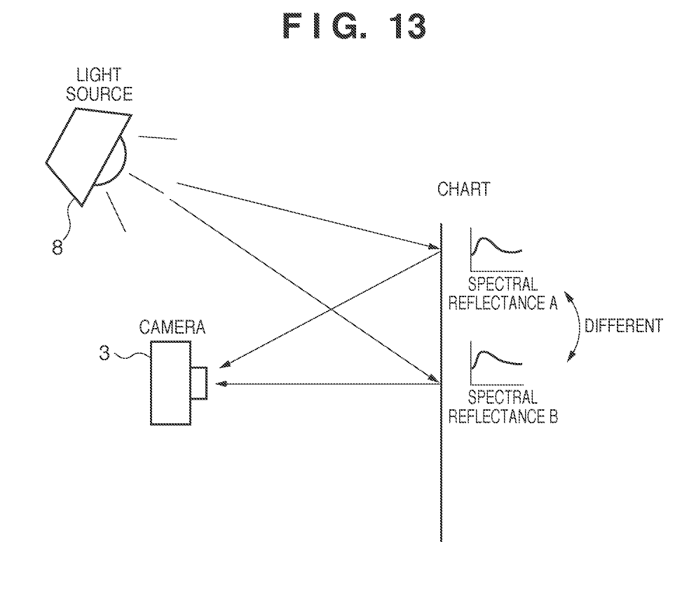

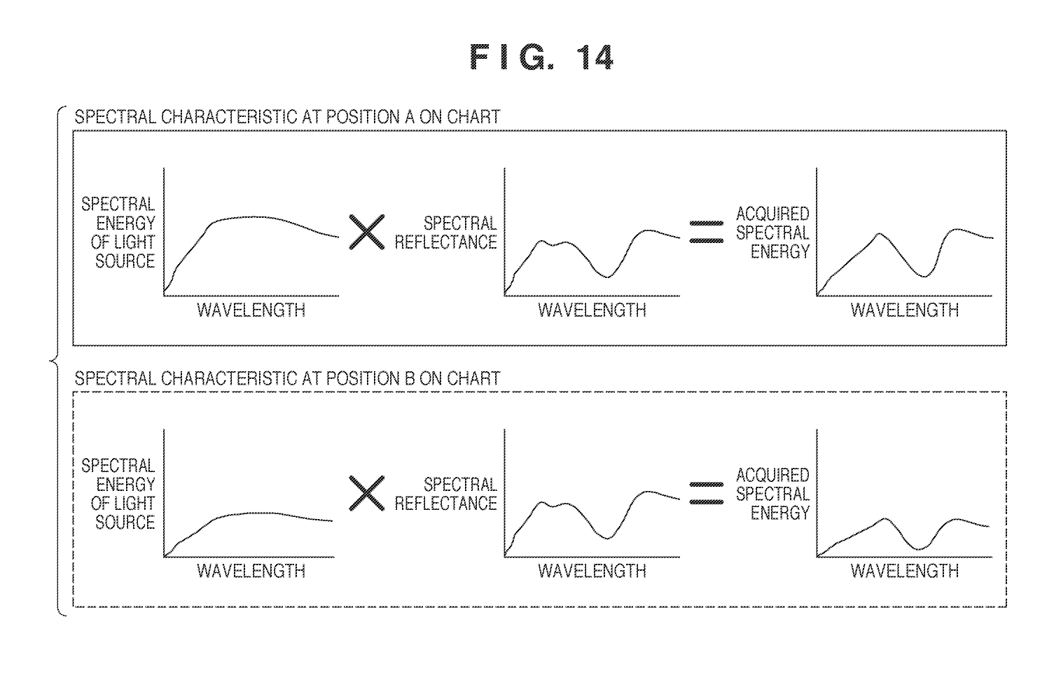

Then, as shown in FIG. 11, the information processing apparatus 1 creates a color conversion table from input RGB values and photographing RGB values (S706). In the embodiment, a color conversion table between RGB and RGB is created. Instead, conversion between CMYK and CMYK, between RGB and CMYK, or between RGB and L*a*b* may be used. In S706, the information processing apparatus 1 creates a color conversion table which uniquely determines a photographing RGB value from an input RGB value, and an inverse color conversion table which uniquely determines an input RGB value from a photographing RGB value. When a plurality of photographing RGB values are equal, input RGB values for RGB values close to the photographing RGB values are averaged to select one closest to the plurality of photographing RGB values. By using the color conversion table created in this manner, the information processing apparatus 1 converts the color of original image data obtained by photographing the original image 4 (S707). The printing apparatus 2 prints the converted original image data (S708). Printing is done under the same conditions as the print conditions of the color chart 5 in 5702.

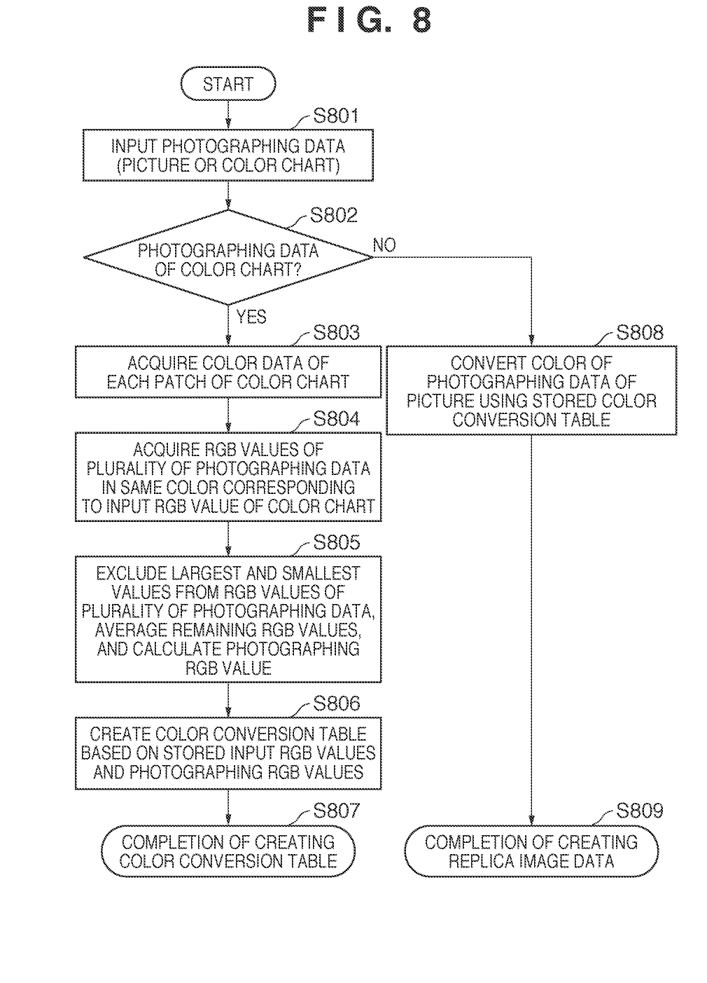

Processing by the information processing apparatus 1 will be explained with reference to FIG. 8. First, the camera 3 inputs photographing data (S801). Color chart identification information is printed on the color chart 5, and the information processing apparatus 1 determines whether the photographing data has been obtained from the color chart 5 (S802). If the information processing apparatus 1 determines that the photographing data has been obtained from the color chart, it acquires color data of all the patches of the color chart 5 (S803). The information processing apparatus 1 acquires the photographing RGB values of patches having the same input RGB value on the color chart 5 (S804). Then, the information processing apparatus 1 excludes the largest and smallest (upper limit and lower limit) values among the values of each color, and average the remaining RGB values, calculating one photographing RGB value for the input RGB value (S805). The information processing apparatus 1 creates a color conversion table from input RGB values and photographing RGB values (S806). The information processing apparatus 1 stores the created color conversion table in the storage area (S807). If the information processing apparatus 1 determines in S802 that the photographing data is data of a picture, it executes color conversion using the color conversion table created in S807 (S808). The information processing apparatus 1 creates replica image data to be transmitted to the printing apparatus 2 (S809).

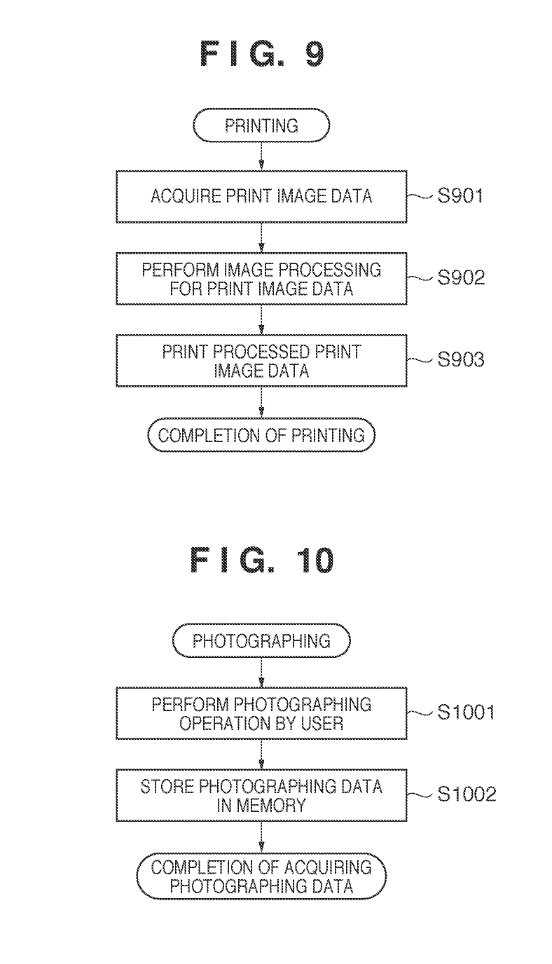

Processing by the printing apparatus 2 will be described with reference to FIG. 9. The printing apparatus 2 acquires print image data transmitted from the information processing apparatus 1 (S901). The print image data may be stored in the printing apparatus or spooled as a job in the network. Then, the printing apparatus 2 performs image processing for the print image data (S902). Image processing by the inkjet printing apparatus 2 generally includes color expansion and halftone processing. The printing apparatus 2 prints the converted print image data, completing printing (S903).

Processing by the camera 3 will be described with reference to FIG. 10. Photographing processing starts after setting the environment conditions of the object, light, camera, and the like. While the object is illuminated and the camera 3 is directed to the object, the user performs a photographing operation (S1001). The camera 3 stores the photographing data in a memory (S1002). The camera 3 transmits the photographing data to the information processing apparatus 1.

As described above, according to the embodiment, the color chart 5 on which patches in the same color are arranged to be distributed on the sheet surface is used to create a color conversion parameter. The color conversion parameter is created based on the read values of a plurality of patches corresponding to each color that are obtained from input color data of the color chart 5 itself and color data of the color chart 5 that are obtained by photographing. This can reduce the influence of the color difference arising from the angular dependence of the spectral reflectance.

In the above-described embodiment, the color chart has 729 patches, but the present invention is not limited to this. That is, as long as at least two patches representing a predetermined color are arranged at different positions on the color chart, the color difference can be corrected by photographing the patches to obtain photographing data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-186144, filed Aug. 10, 2009, and No. 2010-143923, filed Jun. 24, 2010, which are hereby incorporated by reference herein in their entirety.

What is claimed is:

1. A printing method executed in a printing system including a photographing unit for photographing an object, an information processing apparatus, and a printing apparatus, the method comprising:
a first acquisition step of causing the information processing apparatus to acquire photographing data obtained by photographing, by the photographing unit, a color chart formed from a plurality of patches including at least two patches representing a predetermined color;
a second acquisition step of causing the information processing apparatus to acquire photographing data obtained by photographing the object by the photographing unit under the same ambient light as an ambient light used to photograph the color chart in the first acquisition step;
a correction step of causing the information processing apparatus to correct, based on the photographing data of the color chart that has been acquired in the first acquisition step, the photographing data of the object that has been acquired in the second acquisition step; and
a printing step of causing the information processing apparatus to print by the printing apparatus using the photographing data of the object that has been corrected in the correction step.

2. The method according to claim 1, when photographing the object in the second acquisition step, the same light source as a light source used to photograph the color chart in the first acquisition step emits light from the same position, and the photographing unit is arranged at the same position.

3. The method according to claim 1, further comprising a color chart printing step of causing the information processing apparatus to print the color chart by the printing apparatus.

4. The method according to claim 1, in the correction step, data representing the predetermined color out of the photographing data of the object is corrected in accordance with a plurality of photographing data obtained by photographing a plurality of patches representing the predetermined color on the color chart.

5. The method according to claim 1, the color chart has a plurality of regions, and at least two regions out of the plurality of regions include patches representing the predetermined color.

6. The method according to claim 5, each of the plurality of regions includes a plurality of patches on N rows×M columns (N and M are natural numbers).

7. The method according to claim 6, in the plurality of regions including the patches representing the predetermined color, the patches representing the predetermined color are arranged at positions different in at least one of the row and the column.

8. A printing system including a photographing unit for photographing an object, an information processing apparatus, and a printing apparatus, the system comprising:
a first acquisition unit configured to acquire photographing data obtained by photographing, by the photographing unit, a color chart formed from a plurality of patches including at least two patches representing a predetermined color;
a second acquisition unit configured to acquire photographing data obtained by photographing the object by the photographing unit under the same ambient light as an ambient light used to photograph the color chart;
a correction unit configured to correct, based on the photographing data of the color chart that has been acquired by said first acquisition unit, the photographing data of the object that has been acquired by said second acquisition unit; and
a printing unit configured to print by the printing apparatus using the photographing data of the object that has been corrected by said correction unit.
